(19) United States
(12) Patent Application Publication
(10) Pub. No.: US 2012/0262409 A1
(43) Pub. Date: Oct. 18, 2012

(54) TOUCH SENSING UNIT HAVING TOUCH SENSING PATTERN WITH HOLLOW AREAS, AND RELATED TOUCH SENSING ELEMENT AND DEVICE USING THE SAME

(76) Inventors: Yu-Jen Tsai, Taichung City (TW); Hsueh-Wei Yang, Hsinchu County (TW)

(21) Appl. No.: 13/214,238

(22) Filed: Aug. 22, 2011

(30) Foreign Application Priority Data
Apr. 15, 2011 (TW) 100113138

(51) Int. Cl. G06F 3/044

(52) U.S. Cl. 345/174; 178/18.06

(57) ABSTRACT

A touch sensing unit includes an external conductive part and at least one internal conductive part. Each internal conductive part has at least two ends respectively connected to the external conductive part. A sensing pattern constituted by the at least one internal conductive part and the external conductive part includes a plurality of hollow areas.

### BACKGROUND OF THE INVENTION

1. Field of the Invention

The disclosed embodiments of the present invention relate to touch sensing patterns, and more particularly, to a touch sensing unit having a touch sensing pattern with a plurality of hollow areas, and a related touch sensing element and device using the same.

2. Description of the Prior Art

In modern consumer electronic products, portable electronic products, such as tablet personal computers, personal digital assistants (PDAs), mobile phones, GPS systems and audio/video (A/V) players, widely employ touch panel to replace conventional keyboards and act as man-machine interfaces, thereby enhancing variety in practical applications.

Please concurrently refer to FIG. 1 and FIG. 2. FIG. 1 is a schematic diagram illustrating an example of a conventional touch sensing unit 10, and FIG. 2 is a coordinate diagram illustrating an example of an overlapped area between a testing object A and a conventional touch sensing pattern B. As shown in FIG. 1, the touch sensing unit 10 is a capacitive touch sensing unit, and has a diamond-shaped touch sensing pattern B constituted by a conductive part enclosing a diamond-shaped area. When the testing object A, which is a finger in this example, slides on the touch sensing pattern B in a direction X, the testing object A would generate a coupling effect with the conductive part corresponding to the touch sensing pattern B, thus forming a sensing capacitance. The amount of the sensing capacitance is proportional to the size of the overlapped area between the testing object A and the diamond-shaped touch sensing pattern B. As shown in FIG. 2, when the testing object A slides on the conductive part corresponding to the touch sensing pattern B, the overlapped area, as shown by the shadowed area, does not increase linearly due to the fact that the touch sensing pattern B has a diamond shape. In other words, when the testing object A is sliding in the direction X, the sensing capacitance is accumulated non-linearly, which is prone to compromising the sensing accuracy of a touch event.

Therefore, how to enhance the linearity of a touch sensing unit is an important issue in the pertinent field.

### SUMMARY OF THE INVENTION

In accordance with exemplary embodiments of the present invention, a touch sensing unit having a touch sensing pattern with a plurality of hollow areas and a related touch sensing element and device using the same are proposed to solve the above-mentioned problem.

According to a first aspect of the present invention, an exemplary touch sensing unit is disclosed. The touch sensing unit includes an external conductive part and at least one internal conductive part. Each internal conductive part has at least two ends respectively connected to the external conductive part. A sensing pattern constituted by the at least one internal conductive part and the external conductive part includes a plurality of hollow areas.

According to a second aspect of the present invention, an exemplary touch sensing element is disclosed. The touch sensing element includes a carrier board and a plurality of touch sensing units disposed on the carrier board. A sensing pattern of each of the touch sensing units includes a plurality of hollow areas.

According to a third aspect of the present invention, an exemplary touch sensing device is disclosed. The touch sensing device includes a touch sensing element and a control circuit. The touch sensing element includes a carrier board and a plurality of touch sensing units. The plurality of touch sensing units are disposed on the carrier board, the touch sensing unit is arranged for generating a plurality of sensing signals, respectively, and a sensing pattern of each of the touch sensing units includes a plurality of hollow areas. The control circuit is coupled to the touch sensing units, for detecting a touch event according to sensing signal (s) generated by at least one of the touch sensing units.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an example of a conventional touch sensing unit.

FIG. 2 is a coordinate diagram illustrating an example of an overlapped area between a testing object and a conventional touch sensing pattern.

FIG. 3 is a schematic diagram illustrating a touch sensing unit according to a first exemplary embodiment of the present invention.

FIG. 4 is a schematic diagram illustrating a touch sensing unit according to a second exemplary embodiment of the present invention.

FIG. 5 is a schematic diagram illustrating a touch sensing unit according to a third exemplary embodiment of the present invention.

FIG. 6 is a coordinate diagram illustrating an example of an overlapped area between a testing object and a touch sensing pattern PN−1 according to the present invention.

FIG. 7 is a schematic diagram illustrating a touch sensing unit according to a fourth exemplary embodiment of the present invention.

FIG. 8 is a schematic diagram illustrating a touch sensing element according to an exemplary embodiment of the present invention.

FIG. 9 is a functional block diagram illustrating a touch sensing device according to an embodiment of the present invention.

FIG. 10 is a schematic diagram illustrating a touch sensing element according to another exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

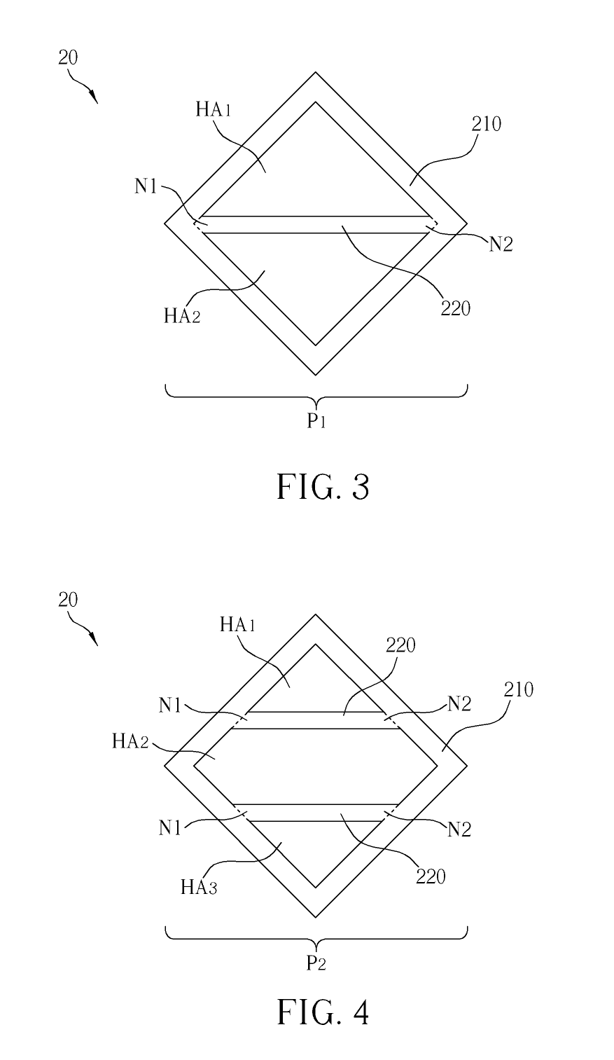

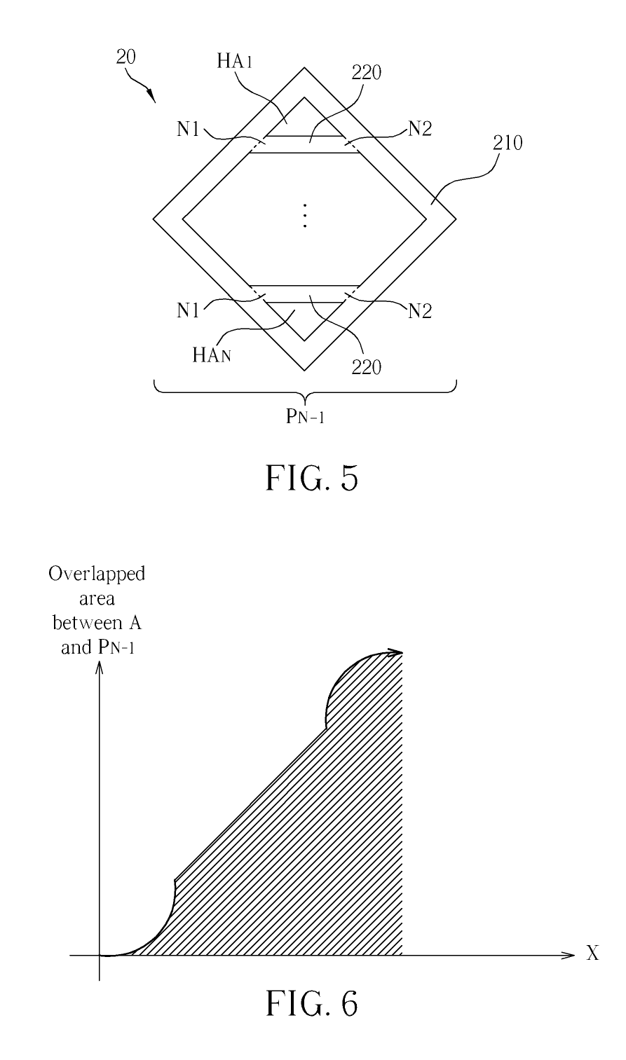

Please concurrently refer to FIG. 3, FIG. 4 and FIG. 5. FIG. 3 is a schematic diagram illustrating a first exemplary embodiment of a touch sensing unit 20 according to the present invention, FIG. 4 is a schematic diagram illustrating a second exemplary embodiment of the touch sensing unit 20 according to a second embodiment of the present invention, and FIG. 5 is a schematic diagram illustrating a third exemplary embodiment of the touch sensing unit 20 according to the present invention. As shown in FIG. 3, the touch sensing unit 20 is a capacitive touch sensing unit, and includes an outer conductive part 210 and at least one inner conductive part 220. However, this is for illustrative purpose only and not meant to be a limitation of the present invention. That is, any touch sensing unit having an exemplary touch sensing pattern disclosed by the present invention should fall within the scope of the present invention. Additionally, the area enclosed by the outer conductive part 210 has a diamond shape. Each inner conductive part 220 is a strip-like sector, where inner conductive part (s) 220 are evenly arranged in the diamond-shaped area in accordance with a direction X parallel with one of the diagonals of the diamond-shaped area; besides, each inner conductive part 220 has at least two nodes N1, N2, respectively connected to the outer conductive part 210. In this embodiment, the number of the inner conductive parts 220 is 1, and thus the inner conductive part 220 and outer conductive part 210 collaboratively form a touch sensing pattern P₁ having two hollow areas HA₁, HA₂ included therein. Similarly, when the number of the inner conductive parts 220 is 2, as shown in FIG. 4, the inner conductive parts 220 and the outer conductive part 210 collaboratively form a touch sensing pattern P₂ having three hollow areas HA₁, HA₂ and HA₃ included therein. By the same token, when the number of the inner conductive parts 220 is N−1, as shown in FIG. 5, the inner conductive parts 220 and the outer conductive part 210 collaboratively form a touch sensing pattern P_{N-1} having N hollow areas HA₁-HA_{N} included therein. In addition, the touch sensing pattern of the touch sensing unit 20 can be obtained by directly punching holes with desired hollow area shapes on a conventional touch sensing pattern of the touch sensing unit 10, or by first removing an interior of the conventional touch sensing pattern of the touch sensing unit 10 to obtain the outer conductive part 210 and then adding the corresponding inner conductive part (s) 220 to the obtained outer conductive part 210.

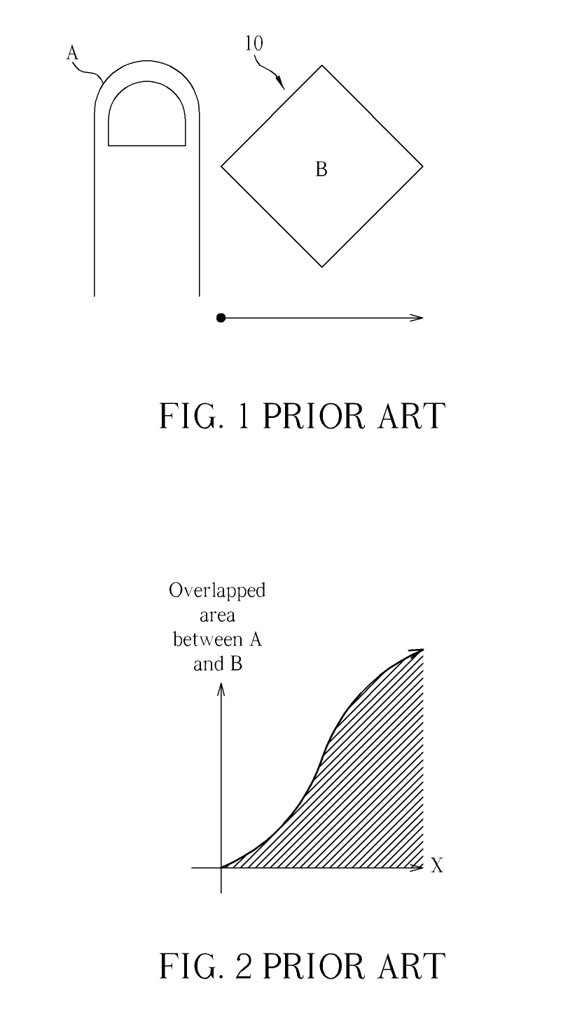

In detail, when the testing object A in FIG. 1, which is a finger in this embodiment, touches/approaches the outer conductive part 210 or the inner conductive part 220 of the touch sensing unit 20, a sensing capacitor is generated due to the coupling effect. Similarly, the amount of the sensing capacitance is in proportion to a size of an overlapped area between the testing object A and the touch sensing unit's conductive part (s) directly touched by the testing object A or sensed by approaching of the testing object A. Hence, the touch event detected by the touch sensing unit 20 can be described by the measured amount, location and variation amount/rate of the sensing capacitance. Please refer to FIG. 6, which is a coordinate diagram illustrating an example of an overlapped area between a testing object A and a touch sensing pattern P_{N-1} according to the present invention. When the testing object A slides on the touch sensing unit 20 in a direction X, the hollow areas HA₁-HA_{N} of the touch sensing pattern P_{N-1} reduces a variation rate of an area of conductive part (s) of the touch sensing unit 20 directly touched by the testing object A or sensed by approaching of the testing object A. Thus, although the outer conductive part 210 encloses a diamond-shaped area, when the testing object A slides in the direction X, the specially designed hollow areas HA₁-HA_{N} in the diamond-shaped area can be used to fine-tune the variation rate of the overlapped area between the testing object A and the touch sensing pattern P_{N-1}, thereby lowering the non-linearity of the touch sensing unit. As can be known from FIG. 6, during the process of sliding the testing object A in the direction X, the overlapped area (as shown by the shadowed area) between the testing object A and the touch sensing pattern P_{N}−1 increases linearly. In this way, when compared to the conventional touch sensing unit 10, the touch sensing unit 20 disclosed by the embodiment of the present invention would have better linearity.

It should be noted, in this embodiment, the hollow areas HA₁-HA_{N} in the touch sensing pattern P_{N-1} are directional with respect to the direction X. However, this is not meant to be a limitation of the present invention. In other words, the spirit of the present invention is to reduce a variation rate of an area of conductive part (s) in the touch sensing unit 20 directly touched by a testing object or sensed by approaching of the testing object via the use of a touch sensing pattern with a plurality of hollow areas, therefore mitigating non-linearity of the touch sensing unit. Variations and modifications made without departing from the spirit of the present invention should fall within the scope of the present invention.

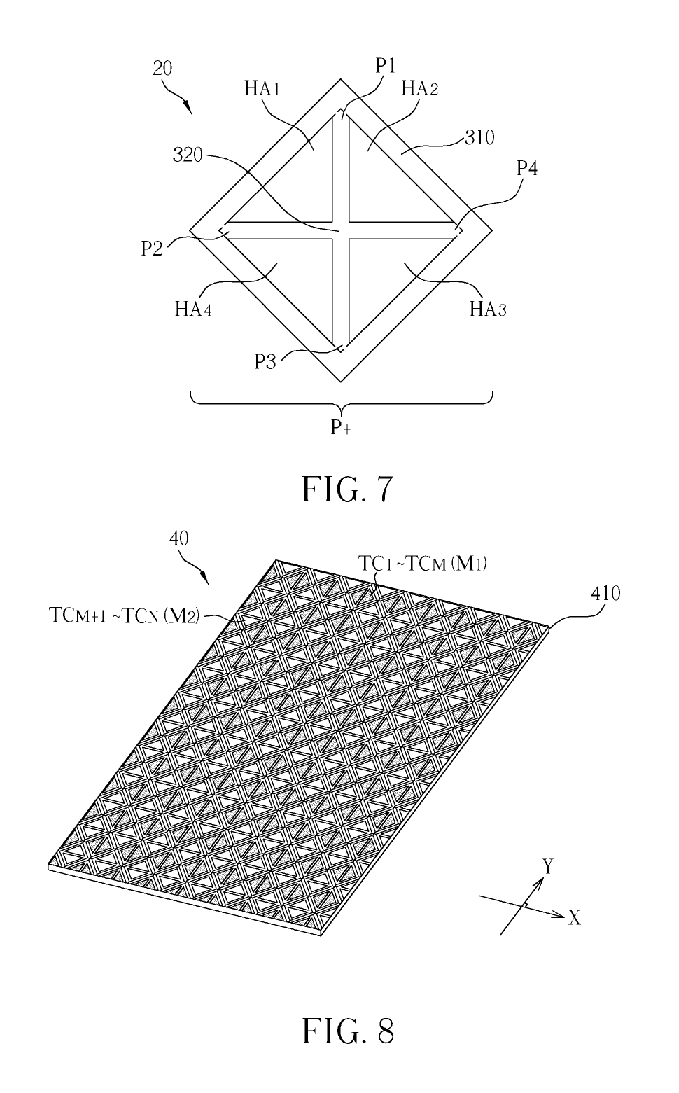

Please refer to FIG. 7, which is a schematic diagram illustrating an exemplary embodiment of another touch sensing unit 30 according to the present invention. For an illustrative purpose, the touch sensing unit 30 partially employs the same notations used by the touch sensing unit 20. As shown in the figure, the touch sensing unit 30 includes an outer conductive part 310 and an inner conductive part 320. The outer conductive part 310 encloses a diamond-shaped area, and the inner conductive part 220 is a cross-shaped block which can be regarded as two strip-like sectors perpendicularly intersected with each other, and therefore has four nodes P1-P4 connected to the outer conductive part 210, respectively. As shown in FIG. 7, the inner conductive part 320 and the outer conductive part 310 constitute a touch sensing pattern P₊ having four hollow areas HA₁-HA₄ included therein. Similarly, as can be easily deduced from the description of FIG. 6, when the testing object A slides on the touch sensing unit 30 in the direction X, the hollow areas HA₁-HA₄ of the touch sensing pattern P₊ can reduce a variation rate of an area of the conductive part 320 in the touch sensing unit 30 that is directly touched by the testing object A or sensed by approaching of the testing object A, thereby enhancing the linearity of the touch sensing unit 30. Such an alternative design also obeys the spirit of the present invention.

In short, the present invention abates a variation rate of an overlapped area between a testing object and a touch sensing pattern via a plurality of hollow areas in a touch sensing pattern, and accordingly mitigates the non-linearity of a touch sensing unit. Therefore, the area enclosed by the outer conductive part of the touch sensing unit is not limited to a diamond-shaped area. Alternatively, it may have a square shape, a circular shape or an irregular shape. Moreover, the shape of the inner conductive part is also not limited to the shapes disclosed by the above mentioned embodiments. Alternatively, the inner conductive part may have an irregular shape like a wavy shape, a saw-tooth shape or an arc shape. To put it another way, the hollow areas in the touch sensing pattern may have any shape as long as the touch sensing pattern is designed to have a plurality of hollow areas included therein. These alternative designs all fall within the scope of the present invention.

Please refer to FIG. 8, which is a schematic diagram illustrating an exemplary embodiment of a touch sensing element 40 according to the present invention. For an illustrative purpose, the touch sensing element 40 partially employs the same notations used by the touch sensing unit 20. The touch sensing element 40 includes a carrier board (e.g., a glass/rigid/flexible circuit board) 410, and a plurality of touch sensing units TC₁-TC_{N} carried on the carrier board 410. Regarding each of the touch sensing units TC₁-TC_{N}, a touch sensing pattern thereof includes a plurality of hollow areas. For example, each of the touch sensing units TC₁-TC_{N} can be implemented using the touch sensing unit 20 shown in FIG. 3. Besides, in this embodiment, each of the touch sensing units TC₁-TC_{N} is a capacitive touch sensing unit. However, this is for illustrative purpose only and not meant to be a limitation of the present invention. That is, any touch sensing unit having a touch sensing pattern disclosed by the present invention falls within the scope of the present invention. The touch sensing units TC₁-TC_{N} include a plurality of first touch sensing units TC₁-TC_{M} and a plurality of second touch sensing units TC_{M+1}-TC_{N}, wherein the first touch sensing units TC₁-TC_{M} have the same first touch sensing pattern P1, the second touch sensing units TC_{M+1}-TC_{N} have the same second touch sensing pattern P2, and the second touch sensing pattern P2 is identical to the first touch sensing pattern P1 rotated by a predetermined angle. In this embodiment, a first direction X is perpendicular to a second direction Y, i.e., the predetermined angle is 90 degrees. As shown in FIG. 8, the first touch sensing units TC₁-TC_{M} are all arranged in the first direction X and therefore form an array M₁ on the carrier board 410, and the second touch sensing units TC_{M+1-TC}_{N} are all arranged in the second direction Y and therefore form an array M₂ on the same carrier board 410. As can be known from FIG. 8, the hollow areas on the first touch sensing units TC₁-TC_{M} are directional with respect tot the direction X such that the linearity of the first touch sensing units TC₁-TC_{M} is significantly enhanced in the direction X. In other words, the design of the touch sensing unit array M1 is utilized for enhancing the linearity in the direction X. Similarly, the design of the touch sensing unit array M₂ is for enhancing the linearity in the direction Y.

It should be noted that the touch sensing unit arrays M1 and M2 are just preferable embodiments of the touch sensing pattern. In other words, the hollow areas of the touch sensing patterns can be directional with respect to other directions in order to improve the linearity in other directions. However, the present invention is not limited to this. That is, in other alternative designs, the present invention may be implemented using touch sensing patterns having a plurality of irregular (non-directional) hollow areas as long as a variation rate of an overlapped area between a testing object and the touch sensing patterns can be effectively reduced to be more linear. Any variations and modifications made without departing from the spirit of the present invention fall within the scope of the present invention.

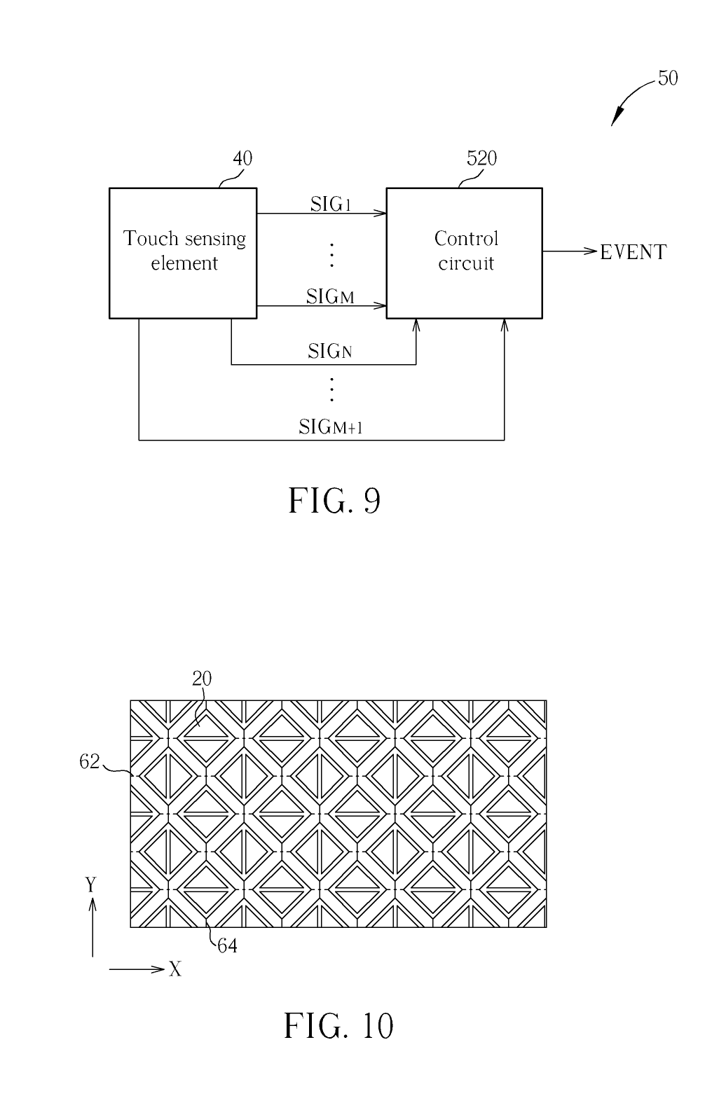

Please concurrently refer to FIG. 8 and FIG. 9. FIG. 9 is a functional block diagram illustrating a touch sensing device 50 according to an embodiment of the present invention. The touch sensing device 50 includes the touch sensing element 40 shown in FIG. 8 and a control circuit 520. In an embodiment, the touch sensing element 40 and the control circuit 520 may be carried on the same carrier board 410. The touch sensing units TC₁-TC_{N} are used for generating a plurality of sensing signals SIG₁-SIG_{N}, respectively. The first touch sensing units TC₁-TC_{M} are arranged based on a first direction X, and utilized for outputting the sensing signals SIG₁-SIG_{M}, respectively. The second touch sensing units TC_{M+1}-TC_{N} are arranged based on a second direction Y, and utilized for outputting the sensing signals SIG_{M+1}-SIG_{N}, respectively. The control circuit 520 is coupled to the touch sensing units TC₁-TC_{N}, and utilized for detecting a touch event EVENT according to sensing signal (s) generated by at least one of the touch sensing units TC₁-TC_{N}. In this embodiment, the touch sensing units TC₁-TC_{N} are capacitive touch sensing units, and thus the sensing signals SIG₁-SIG_{N} can be realized by sensing capacitance sensed by the touch sensing units TC₁-TC_{N}. That is, the touch event EVENT can be defined by the amount, location and variation amount/rate of the sensing capacitance . For example, when a testing object A (which is a finger in this embodiment) slides on the touch sensing units TC₁-TC_{N} in direction X, the touch sensing units TC₁-TC_{N} would generate a sensing capacitor due to coupling and accordingly output the sensing signals SIG₁-SIG_{N}. Since the amount of the sensing capacitance is in proportion to the size of an area of conductive parts of the touch sensing units TC₁-TC_{N} directly touched by the testing object A or sensed by approaching of the testing object A, the control circuit 520 can detect that the touch event EVENT is a finger-sliding event according to the variation rate of the sensing capacitance indicated by the sensing signals SIG₁-SIG_{N}. The touch sensing device 50, which employs the touch sensing unit disclosed by the present invention, can be applied to all kinds of consumer electronic products, such as tablet personal computers, personal digital assistants, mobile phones, satellite navigation systems, A/V players, etc.

In the embodiment shown in FIG. 10, a touch pad includes a plurality of sensing traces 62 disposed in the direction X and a plurality of sensing traces disposed 64 in the direction Y, wherein each of the sensing traces includes a plurality of touch sensing units cascaded in series, and the X-direction sensing traces 62 and the Y-direction sensing traces 64 are not electrically connected. For example, regarding a touch pad realized using a double-layered carrier board, there may be an insulation layer located in between the X-direction sensing traces 62 and the Y-direction sensing traces 64. Regarding a touch pad realized using a single-layered carrier board, the touch sensing units of the X-direction sensing traces 62 and the Y-direction sensing traces 64 are coplanar, and electrically disconnected from each other by placing a plurality of insulators at intersections of the X-direction sensing traces and the Y-direction sensing traces. The touch sensing unit may be implemented using that shown in FIG. 3, FIG. 4 or FIG. 5, and the sensing traces are perpendicular to the inner conductive part (s) of the touch sensing unit.

To sum up, the present invention provides a touch sensing unit, and related touch sensing element and device using the same. Due to the touch sensing unit having a touch sensing pattern with a plurality of hollow areas, the present invention can lower a variation rate of an area of conductive part (s) in the touch sensing unit directly touched by a testing object or sensed by approaching of the testing object, thereby enhancing the linearity of the touch sensing unit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch sensing unit, comprising:
an external conductive part; and
at least one internal conductive part, each internal conductive part having at least two ends respectively connected to the external conductive part, wherein a sensing pattern constituted by the at least one internal conductive part and the external conductive part includes a plurality of hollow areas.

2. The touch sensing unit of claim 1, being a capacitive touch sensing unit.

3. The touch sensing unit of claim 1, wherein the hollow areas are directional.

4. The touch sensing unit of claim 1, wherein the external conductive part surrounds a diamond-shaped region, and each internal conductive part is a strip-shaped region.

5. A touch sensing element, comprising:
a carrier board; and
a plurality of touch sensing units, disposed on the carrier board, wherein a sensing pattern of each of the touch sensing units includes a plurality of hollow areas.

6. The touch sensing element of claim 5, wherein each of the touch sensing units is a capacitive touch sensing unit.

7. The touch sensing element of claim 5, wherein the touch sensing units comprise:
a plurality of first touch sensing units, having an identical first sensing pattern; and
a plurality of second touch sensing units, having an identical second sensing pattern, wherein the second sensing pattern is identical to the first sensing pattern rotated by a predetermined angle.

8. The touch sensing element of claim 7, wherein the first touch sensing units are arranged on the carrier board in a first direction, the second touch sensing units are arranged on the carrier board in a second direction, and the first direction is perpendicular to the second direction.

9. A touch sensing device, comprising:
a touch sensing element, comprising:
a carrier board; and
a plurality of touch sensing units, disposed on the carrier board, the touch sensing unit arranged for generating a plurality of sensing signals, respectively, a sensing pattern of each of the touch sensing units includes a plurality of hollow areas; and
a control circuit, coupled to the touch sensing units, for detecting a touch event according to sensing signal(s) generated by at least one of the touch sensing units.

10. The touch sensing device of claim 9, wherein each of the touch sensing units is a capacitive touch sensing unit.

11. A touch pad, comprising:
a carrier board; and
a plurality of first traces arranged in a first direction, wherein the first traces are parallel with each other and disposed on the carrier board, the first traces include a plurality of first touch sensing units connected in series, and each of the first touch sensing units has a plurality of hollow areas included therein.

12. The touch pad of claim 11, further comprising:
a plurality of second traces arranged in a second direction, wherein the second traces are parallel with each other and disposed on the carrier board, the second traces include a plurality of second touch sensing units connected in series, and each of the second touch sensing units has a plurality of hollow areas included therein;
wherein the first traces and the second traces are not electronically connected.

13. The touch pad of claim 11, wherein each of the first touch sensing units comprises an external conductive part and at least one internal conductive part, each internal conductive part has at least two ends respectively connected to the external conductive part, a sensing pattern constituted by the at least one internal conductive part and the external conductive part includes the hollow areas, and the at least one internal conductive part is perpendicular to the first direction.

14. The touch pad of claim 12, wherein each of the second touch sensing units comprises an external conductive part and at least one internal conductive part, each internal conductive part of the second touch sensing unit has at least two ends respectively connected to the external conductive part of the second touch sensing unit, a sensing pattern constituted by the at least one internal conductive part and the external conductive part of the second touch sensing unit includes the hollow areas, and the at least one internal conductive part is perpendicular to the second direction.

15. The touch pad of claim 12, wherein the first touch sensing units and the second touch sensing units are coplanar.

16. The touch pad of claim 12, further comprising:
an insulation layer, located in between the first traces and the second traces.
